(19) United States
(12) Patent Application Publication
(10) Pub. No.: US 2007/0141710 A1
(43) Pub. Date: Jun. 21, 2007

(54) Stable calibrators for immunoassays

(75) Inventors: Jose E. Gaibor, Richfield, MN (US); Dean G. Binger, Saint Louis Park, MN (US)

Correspondence Address: BECKMAN COULTER, INC., P.O. BOX 169015, MAIL CODE 32-A02, MIAMI, FL, 33116-9015, US

(73) Assignee: Beckman Coulter, Inc., Fullerton, CA (US)

(21) Appl. No.: 11/312,721

(22) Filed: Dec. 20, 2005

(51) Int. Cl. G01N 31/00

(52) U.S. Cl. 436/8

(57) ABSTRACT

Compositions, methods, and kits comprising calibrators with enhanced stability for immunoassays are provided. The compositions and kits of the invention comprise calibrators that have been linearized. They include calibrators that have been exposed, in a denatured state, to at least one ionic surface charge modifier, and they include calibrators that have been denatured in the presence of an ionic surface charge modifier. Ionic surface charge modifiers include, for example, sodium dodecyl sulfate. Methods for preparing calibrator preparations of enhanced stability, including methods that comprise exposing a calibrator preparation to an ionic surface charge modifier while the calibrator is in a denatured state, are provided. The compositions and kits include calibrators that are protein/polypeptide antigens and non-protein/polypeptide antigens and haptens. The compositions and kits include calibrator media for immunoassays prepared in accordance with the invention. Stabilized matrices for liquid immunoassays are also provided.

### FIELD OF INVENTION

The present invention relates to stabilized protein, polypeptide, or non-protein hapten calibrators for use in immunoassays.

### BACKGROUND

In both the research laboratory and in the clinical laboratory, materials that contain protein, or non-protein haptens, are qualitatively and quantitatively analyzed by antibodies.

Effective immunological analysis depends on the availability of reliable standards. Unfortunately, in spite of the continued reliance on immunoassays in both the clinic and the research lab, immunological analysis continues to be plagued by the limited availability of suitably stable assay standards for calibrating immunoassays.

Degradation of immunoassay calibrator performance over time, and variability in the quality of immunoassay calibrator preparations, renders comparison of immunoassay results carried out with different calibrator preparations, or with the same calibrator preparation at different times or in different places, difficult. This unreliability is, in large part, due to the instability of calibrators that are in native form, and calibrators in mixtures, which can undergo changes with time and storage conditions.

Instability in calibrator preparations can be due to factors such as the presence of proteases, endo/exoglycosydases, structural instability, and inherent instability such as, for example, autoproteolysis as observed, for example, in trypsin preparations. This instability has a negative impact on calibrator reliability and lot-to-lot variability in calibrator preparations. Therefore, protein, polypeptide, and non-protein hapten calibrators with enhanced stability are needed for reliable and robust immunoassay interpretation in applications that include, but are not limited to, diagnostic immunoassays.

### SUMMARY OF INVENTION

The present invention provides useful compositions, methods, and kits for stable immunoassay calibrators.

The stable calibrators of the invention comprise proteins or polypeptides that have been denatured in the presence of an ionic surface charge modifier. The stable calibrators of the invention also comprise non-protein antigens or haptens that have been exposed to conditions sufficient to denature protein, in the presence of an ionic surface charge modifier. In various embodiments, the proteins, polypeptides, non-protein antigens, or haptens have been exposed to heat in the presence of an ionic surface charge modifier. In various embodiments, the proteins, polypeptides, non-protein antigens, or haptens can be present in a mixture, for example, in human serum. In various embodiments, the proteins, polypeptides, non-protein antigens, or haptens are substantially free of protein or polypeptide contaminants.

In one aspect, the invention provides a stable immunoassay calibrator preparation, comprising: (a) a polypeptide antigen, protein antigen, non-protein antigen or hapten, wherein the polypeptide antigen, protein antigen, non-protein antigen or hapten comprises an epitope that is recognized by an antibody; and (b) an ionic surface charge modifier.

In another aspect, the invention provides a method for preparing a stable calibrator for an immunoassay, said method comprising the step of denaturing a polypeptide antigen or a protein antigen in the presence of an ionic surface charge modifier, wherein the polypeptide antigen or the protein antigen comprises an epitope that is specifically recognized by an antibody.

In another aspect, the invention provides a method for preparing a stable calibrator for an immunoassay, said method comprising the step of exposing a non-protein antigen or hapten to conditions sufficient to denature protein, in the presence of an ionic surface charge modifier, wherein the non-protein antigen or hapten comprises an epitope that is specificallly recognized by an antibody.

In another aspect, the invention provides stable calibrators and methods for making stable calibrators, and kits comprising them, wherein the stable calibrators and kits comprise a protein, a polypeptide, a non-protein antigen or hapten, wherein the protein, polypeptide, non-protein antigen or hapten comprises an epitope that is specifically recognized by an antibody.

In another aspect, the invention provides a stabilized matrix for a calibrator for an immunoassay. The matrix can be any matrix suitable for storing a protein, polypeptide, or non-protein hapten calibrator. The stabilized matrix is prepared by exposing a matrix to an ionic surface charge modifier under conditions sufficient for denaturing proteins or polypeptides, in accordance with any of the embodiments of the invention. Any suitable matrix known in the art can be employed. Suitable matrices include matrices used by those of skill in the art for immunoassays of proteins, polypeptides, non-protein antigens or haptens.

In another aspect, the invention provides kits for immunoassays, wherein the kits comprise a stabilized matrix for an immunoassay calibrator, wherein the stabilized matrix is prepared according to any of the embodiments of the invention.

In various embodiments, the invention provides a calibrator kit for an immunoassay, comprising a polypeptide antigen or protein antigen, wherein the protein or polypeptide has been denatured in the presence of an ionic surface charge modifier, and wherein the protein or polypeptide comprises an epitope that is recognized by an antibody.

In various embodiments, the invention provides a stable calibrator kit for an immunoassay, comprising a non-protein antigen or hapten, wherein the non-protein antigen or hapten has been exposed to conditions sufficient to denature a protein in the presence of an ionic surface charge modifier in accordance with any of the embodiments of the invention, and wherein the non-protein antigen or hapten comprises an epitope that is recognized by an antibody.

In various embodiments, the invention provides a calibrator kit for an immunoassay, comprising: (a) a calibrator preparation comprising a polypeptide antigen or protein antigen, wherein the polypeptide antigen or protein antigen comprises an epitope that is recognized by an antibody, and the polypeptide antigen or protein antigen has been heated in the presence of an ionic surface charge modifier at one or more temperatures from about 80° C. to 100° C. for a period of time from about one minute to 15 minutes; and (b) an antibody that recognizes the polypeptide antigen or protein antigen.

In various embodiments, the invention provides a calibrator kit for an immunoassay, comprising: (a) a calibrator preparation comprising a non-protein antigen or hapten, wherein the non-protein antigen or hapten comprises an epitope that is recognized by an antibody, and the non-protein antigen or hapten has been heated in the presence of an ionic surface charge modifier at one or more temperatures from about 80° C. to 100° C. for a period of time from about one minute to 15 minutes; and (b) an antibody that recognizes the non-protein antigen or hapten.

In various embodiments, the invention provides a kit for an immunoassay, comprising: (a) a calibrator preparation comprising a polypeptide or protein antigen, wherein the polypeptide antigen or protein antigen comprises an epitope that is recognized by an antibody; (b) a stabilized matrix comprising an ionic surface charge modifier, wherein the stabilized matrix comprising the ionic surface charge modifier has been heated at one or more temperatures from about 80° C. to 100° C. for a period of time from about one minute to about 30 minutes; and (c) an antibody that recognizes the polypeptide antigen or protein antigen.

In various embodiments, the invention provides a kit for an immunoassay, comprising: (a) a calibrator preparation comprising a non-protein antigen or hapten, wherein the non-protein antigen or hapten comprises an epitope that is recognized by an antibody; (b) a stabilized matrix comprising an ionic surface charge modifier, wherein the stabilized matrix comprising the ionic surface charge modifier has been heated at one or more temperatures from about 80° C. to 100° C. for a period of time from about one minute to about 30 minutes; and (c) an antibody that recognizes the non-protein antigen or hapten.

### DETAILED DESCRIPTION OF INVENTION

The present invention is based at least in part on the observation that calibrator preparations for immunoassays are stabilized by exposing calibrator preparations to conditions sufficient to denature protein in the preparation. Such conditions include, but are not limited to, heating the preparation in the presence of an ionic surface charge modifier.

Calibrator preparations for immunoassays can be stabilized by linearizing protein or polypeptide antigens in the calibrator preparation, including protein or polypeptide antigens that are not typically stored or immunoassayed in a linearized state. A linearized protein or polypeptide antigen, under most circumstances, is typically far less susceptible to degradation—and thus more stable—than when present in its native state. This is particularly true for most preparations wherein the antigen is present in a complex mixture (or where the antigen preparation is not wholly free from other proteins) where destabilizers such as proteases or glycosylases may be present even in minute amounts.

Destabilizers such as proteases or glycosylases can result in significant performance degradation of antigen preparations such as calibrator preparations, even when present in minute amounts, particularly where an antigen is stored for an extended period of time at one or more temperatures that allows destabilization to occur. Minute amounts of destabilizers in a calibrator preparation can significantly degrade calibrator performance where calibrators are stored at conditions that allow, for example, proteases and/or glycosylases to remain active. For example, a minute amount of protease activity can severely degrade performance of a calibrator over time where the calibrator preparation is stored for weeks or months above, for example 5° C., particularly where the protease itself remains functional in the preparation at the storage temperature.

Linearization of the antigen, and/or linearization of destabilizers present in an antigen preparation, will result in improved stability even at temperatures above 5° C., including in many cases at temperatures around room temperature (about 25° C.) or above. Linearization of the antigen in many cases may render it resistant to degradation by enzymes that recognize tertiary or secondary structure in the antigen. And linearization of proteases and glycosylases present in an antigen preparation that can act on the antigen will in many cases prevent or inhibit degradation of the antigen. Linearization can be employed not only for antigens that are only stable and/or soluble in denaturing solutions, but can be applied in general to preparations of any suitable antigen for immunoassay. Suitable antigens include proteins, polypeptides, non-protein antigens, and haptens.

Among the advantages of the invention include the ability to stabilize an antigen without resort to maintaining the calibrator in a preparation that contains undesirably high levels of harsh chaotropic agents and the like. Although preparing an antigen in 6-8 M urea or guanidinium hydrochloride can result in linearization of the antigen (and/or destabilizers such as proteases and glycosylases), one disadvantage is that the 6-8 M urea or guanidinium hydrochloride must be diluted out before use in an immunoassay. Similarly, it is preferable not to use materials such as dimethyl sulfoxide, ethanol, mercaptoethanol, or dithiothreitol at concentrations that would interfere with an immunoassay (such as concentrations that would result in undesirable variance in immunoassay results, or reductions in accuracy). To partially compensate for potential problems in an immunoassay, antigens in such preparations are typically present at relatively high concentration so as to be able to dilute the preparation away from undesirably high amounts of such materials prior to immunoassay. Preparing calibrators having such high concentrations is often not feasible or not convenient. The calibrator antigen may be present in a complex mixture such as, for example, human serum. Or it may be undesirable to prepare dilutions of a calibrator preparation each time the calibrator preparation is used in an assay due to imprecision in making the dilutions. Thus, it is preferable to avoid 6-8 M urea or guanidinium hydrochloride and high concentrations of ethanol or organic solvents in preparing a stable calibrator in accordance with the invention.

Another advantage of the invention is that it provides a stabilized matrix for calibrators. A stabilized matrix comprises a matrix that has been prepared in accordance with any of the methods of the invention. In this aspect, a matrix that lacks an antigen of interest is treated in accordance with the invention and then employed as a stabilized matrix for use with any suitable calibrator. Suitable calibrators include protein antigens, peptide antigens, non-protein antigens or haptens. According to this aspect of the invention, the matrix lacks an antigen of interest when the matrix is treated in accordance with the invention. The advantage of treating a matrix in this way results from the observation that a matrix may contain one or more destabilizers such as, for example, one or more glycosylases or proteases. By treating the matrix in accordance with the invention, the activity of destabilizers in the matrix is reduced or eliminated. The stabilized matrices of the invention are suitable for use with liquid immunoassays.

In one non-limiting example, a matrix containing one or more destabilizers that are enzymes (such as, for example, one or more proteases or glycosylases) capable of degrading an antigen is treated in accordance with the invention, thus inactivating the destabilizing enzyme(s) present in the matrix. The inactivation results from treatment of the matrix in accordance with the invention, i.e., by exposing the matrix to conditions sufficient to denature any proteins or polypeptides in the matrix in the presence of an ionic surface charge modifier. In this aspect of the invention it is not necessary to treat the protein antigen, polypeptide antigen, non-protein antigen, or hapten before placing it in the treated matrix. However, the option of treating the protein antigen, polypeptide antigen, non-protein antigen or hapten in accordance with the invention and separately treating a matrix in accordance with the invention, then combining the separately treated preparations to prepare a stable calibrator preparation, is not precluded.

In one embodiment, the invention comprises linearizing a protein or polypeptide antigen in a matrix that lacks high concentrations of one or more of urea, guanidinium hydrochloride, or high concentrations of organic solvents such as, for example, ethanol or dimethyl sulfoxide. In one embodiment, linearization occurs in the absence of one or more of urea, guanidinium hydrochloride, ethanol, and dimethyl sulfoxide. In another embodiment, linearization occurs in the absence of one or more of mercaptoethanol and dithiothreitol. In another embodiment, a composition or kit in accordance with the invention comprises a calibrator preparation that is free of one or more of urea, guanidinium hydrochloride, ethanol, and dimethyl sulfoxide.

The matrix of the invention preferably does not contain an amount of chaotropic agent, such as, for example, urea or guanidinium hydrochloride, in an amount sufficient to denature a protein or polypeptide. Preferably, the matrix contains less than about 1 M chaotropic agent such as, for example, urea or guanadinium hydrochloride. More preferably, the matrix contains less than 1 mM urea or guanidinium hydrochloride. Most preferably, the matrix lacks urea and lacks guanidinium hydrochloride. Preferably, the ionic surface charge modifier of the matrix is SDS. The matrix can be conveniently treated as described in other embodiments, e.g., at one or more temperatures between about 80° C. and about 100° C. for one to 30 minutes in the presence of SDS in a concentration from about 0.04 to about 0.33 weight percent. A convenient treatment is heating at one or more temperatures from about 90° C. to about 100° C. for about five to about 15 minutes in the presence of about 0.04 to about 0.33 weight percent SDS.

Another advantage of certain aspects of the invention is the option of calibrating and performing the immunoassay of the analyte using the same or similar protocol. The invention does not require that a denatured antigen (e.g., in a calibrator preparation in accordance with the invention) be diluted into preparations having high concentrations of harsh chaotropic agents or dimethyl sulfoxide or ethanol. Preferably, a calibrator in accordance with the invention is diluted prior to immunoassay—if dilution is necessary—in a medium or matrix in the absence of a denaturing amount of one or more of urea, guanidinium hydrochloride, ethanol, dimethyl sulfoxide, mercaptoethanol, and dithiothreitol. Preferably, there is no measureable amount of one or more of urea, guanidinium hydrochloride, ethanol, dimethyl sulfoxide, mercaptoethanol, and dithiothreitol.

The invention is based, at least in part, on the observation that linearizing an antigen in many cases stabilizes the antigen. Linearization can be achieved through any suitable means. Suitable means includes—but is not limited to—heating the antigen in the presence or absence of a denaturing agent. Suitable means includes exposing the antigen to a linearizing agent sufficient to linearize the antigen. A suitable method for linearizing the antigen is to expose the antigen, or calibrator, in a denatured state to an ionic surface charge modifier. Once exposed in a denatured state to an ionic surface charge modifier, the calibrator can be stored in the presence of the ionic surface charge modifier for extended periods without significant decay in stability. It is believed that one function of the ionic surface charge modifier is to prevent re-naturation, or re-folding, of linearized molecules. The invention is suitable for calibrators in purified form, calibrators that have been substantially isolated from protein contaminants, and for calibrator preparations that comprise a complex mixture of both protein and non-protein components, for example, human serum.

The stability conferred by exposure of a denatured calibrator to an ionic surface charge modifier can be retained in some circumstances even where the ionic surface charge modifier has been diluted to relatively low concentration. For example, in embodiments where the ionic surface charge modifier is a detergent, enhanced stability can still be observed over time in certain circumstances on storage of the calibrator in a diluted liquid preparation wherein the concentration of the detergent is at or below its critical micellar concentration.

Calibrator stability can be achieved by inactivating both external sources of instability and autolysis that are present when a calibrator is in its native (i.e., nondenatured) state. Instability and autolysis are reduced or eliminated by denaturation and application of a uniform charge to the calibrator protein or polypeptide using an ionic surface charge modifier. Further, once a calibrator has been exposed to an ionic surface charge modifier in a denatured state, the treated calibrator can continue to exhibit enhanced stability over preparations known to the art even when the ionic surface charge modifier is diluted, such as when the calibrator has been diluted to working strength for an immunoassay.

Enhanced stability on dilution should also be observed in the case of calibrator preparations that comprise a non-protein antigen or hapten, because the enzymes that can destabilized the non-protein antigen or hapten have been exposed to the ionic surface charge modifier in a denatured state as well. For non-protein antigens or haptens employed as calibrators, stability is believed to be achieved, at least in part, by inactivating or inhibiting molecules that tend to decrease the stability of the non-protein hapten. For example, where the hapten is a metabolite that is capable of being acted upon by, for example, an enzyme present in a calibrator mixture, treatment of the calibrator mixture in accordance with any of the embodiments of the invention will increase the stability of the hapten by denaturing the enzyme. Thus, treating the sample comprising the non-protein hapten calibrator in accordance with the invention affords increased stability of the non-protein antigen or hapten calibrator.

The performance of a calibrator in an immunoassay is often a reflection of the stability of the calibrator in the preparation in which it is stored. For an immunoassay calibrator, stability is measured by changes in performance in an immunoassay with length of storage of the calibrator. Where the calibrator is an antigen standard (or reference) for an immunoassay, performance is measured by the ability of a fixed amount of the calibrator to bind a specific antibody over time when stored under a set of conditions, for example, ambient temperature and pressure. Significant decay in calibrator performance (i.e., the same amount of calibrator yields different or fluctuating levels of signal over time) can be detrimental to interpreting immunoassay results. Decay in performance is often due to instability of the calibrator in its native state in an untreated calibrator preparation. Decay in performance can also be due to instability of the calibrator because degradative enzymes are in their native state in an untreated calibrator preparation. The compositions, methods, and kits of the present invention provide enhanced stability as compared to calibrators stored in their native state. Enhancing calibrator stability translates into better confidence in results, lower costs, and better assay uniformity.

Calibrator preparations of improved stability are desirable because many calibrators known in the art are employed in their native state, in substantially isolated form or in a complex mixture (such as, for example, in human serum). Many calibrators in their native state, due to varying levels of instability that vary according to the composition of the calibrator preparation, exhibit non-uniform instability.

The compositions, kits, and methods of the present invention enhance calibrator stability by minimizing instability effects due to calibrators being stored in their native state-where they remain susceptible to significant degradation in performance. They also enhance stability by minimizing instability effects due to destabilizing enzymes in an antigen preparation or in a matrix in which the antigen is stored or assayed. Thus, calibrator preparations made in accordance with the present invention, at various locations and at various times, will preferably exhibit similar, or about the same, stability independent of storage temperature and time of storage. Accordingly, assay results from diverse geographic areas obtained at diverse times using stable calibrators in accordance with the present invention will generally be more uniform and thus more comparable than results achieved by presently in the art using preparations that have not been treated in accordance with the invention.

Methods according to the invention include exposing a calibrator to an ionic surface charge modifier for at least a period of time in which the calibrator is in a denatured state. In various embodiments, the treatment includes denaturation by heating the antigen and exposing the denatured antigen to the ionic surface charge modifier. The calibrator may be exposed to the ionic surface charge modifier before, during, and after denaturation by heat. Further, the calibrator is stored in the solution that comprises the ionic surface charge modifier. Calibrators prepared according to the methods of the invention exhibit enhanced stability as compared to untreated calibrators when stored at ambient temperatures for many months, even up to a year or longer without a significant negative impact on calibrator performance.

A “polypeptide antigen” or “protein antigen” as used herein is meant to include polypeptides and proteins that are capable of being recognized by an antibody. The phrases “polypeptide antigen” and “protein antigen” comprise peptides, polypeptides and proteins that comprise other groups or moieties than amino acids, for example, the phrases include proteins with sugar or carbohydrate moieties thereon, proteins with modified amino or carboxyl groups, and the like.

The phrases “polypeptide antigen” and “protein antigen” also include any antigens covalently attached to suitable moieties known in the art that are used with proteins or polypeptides for making antibodies to antigens, such as, for example, keyhole limpet hemocyanin.

The phrases “polypeptide antigen” and “protein antigen” also include any antigens covalently attached to suitable moieties or modified by functional groups known in the art that are used with proteins or polypeptides for the purpose of immobilization to a solid phase.

The phrases “polypeptide antigen” and “protein antigen” also include any suitable fusions with proteins or polypeptides known to be useful in the art for expressing proteins, for example, glutathione-S-transferase (GST) fusions, polyhistidine fusions, bacterial leader sequences, and the like.

The phrase “non-protein antigen or hapten” includes antigens that are not proteins or polypeptides, and includes substances that cannot induce antibody formation by themselves, but can be made to do so by coupling them to a larger carrier molecule, for example, a protein. Where the term “antigen” is employed by itself (i.e., without specifying that the antigen is a protein, polypeptide, non-protein or hapten), the term “antigen” is meant to include proteins, polypeptides, non-protein antigens and haptens. Examples of non-protein antigens or haptens include small molecules such as, for example, hormones such as progesterone, sterioids, drugs of abuse, etc.

In one aspect, the invention provides a stable immunoassay calibrator preparation, comprising: (a) a polypeptide antigen, protein antigen, non-protein antigen or hapten, wherein the polypeptide antigen, protein antigen, non-protein antigen or hapten comprises an epitope that is recognized by an antibody; and (b) an ionic surface charge modifier.

In various embodiments, the stable immunoassay calibrator preparation comprises a liquid. Where the preparation is a liquid, the calibrator can be present in any suitable concentration. Suitable concentrations preferably include a concentration of from 1×10⁻³ gram/ml to 5×10⁻⁶ gram/ml, from 1×10⁻⁶ gram/ml to 5×10⁻⁹ gram/ml. Suitable concentrations also include lower concentrations, such as, for example, 1×10⁻⁶ gram/ml to 1×10⁻¹² gram/ml, such as where the calibrator is an element in a complex mixture, for example, an element of human serum.

Liquid calibrator preparations can be prepared at any suitable concentration and diluted, or concentrated, for use in an immunoassay. In liquid preparations, the calibrator can be present in a suspension or in solution, or in preparation wherein the calibrator is present in solution and in suspension. One example of preparation where the calibrator can be present in both solution and suspension is a liquid preparation comprising ammonium sulfate in a concentration such that the calibrator is in solution and in suspension.

In various embodiments, the stable immunoassay calibrator preparation is in a non-liquid form. One example of a calibrator preparation that is in a non-liquid form is a preparation that results from lyophilization of a liquid calibrator preparation. In other embodiments, the calibrator preparation can be made by aggregating, precipitating, or crystallizing the calibrator from a liquid preparation. Calibrators so prepared can be suspended or solvated in a suitable buffer for use in an immunoassay.

In various embodiments, the ionic surface charge modifier comprises a charged polymer. The ionic surface charge modifier may comprise a cationic detergent, a zwitterion, a fatty acid, a charged lipid, a phospholipid, a sulfolipid, an anionic detergent, or the salt of a fatty acyl sulfate anion. The ionic surface charge modifier may be derived from natural sources, or synthetic. In a specific embodiment, the ionic surface charge modifier is sodium dodecyl sulfate (SDS). In various embodiments, two or more ionic surface charge modifiers (such as those selected from the aforementioned group) are used together in equal or varying ratio with respect to one another.

The ionic surface charge modifier is present in a concentration suitable for stabilizing the protein antigen or polypeptide antigen when the protein or polypeptide antigen is in a denatured state. In a preparation without a protein or polypeptide antigen of interest but instead a non-protein antigen or hapten of interest, the ionic surface charge modifier is present at a concentration suitable for stabilizing the non-protein antigen or hapten. Suitable concentrations of ionic surface charge modifier will vary somewhat with the identity and concentration of the protein antigen or polypeptide antigen and with the identity of the ionic surface charge modifier. Suitable concentrations may also vary in preparations comprising a non-protein antigen or hapten.

A person of ordinary skill in the art, after reading this disclosure, will recognize that there are suitable methods for determining the utility of a particular putative surface charge modifier. These methods include, for example, selecting a suitable candidate ionic surface charge modifier (such as, for example, a suitable anionic detergent, anionic lipid, cationic lipid, zwitterionic lipid, phospholipids, etc.) and exposing a selected antigen to varying concentrations of the putative ionic surface charge modifier in the presence of a suitable denaturing condition, such as heat, suitable for denaturing the antigen. When determining the utility of a particular ionic surface charge modifier for preparations comprising a non-protein antigen or hapten of interest but not a protein or polypeptide antigen of interest, the preparation comprising the non-protein antigen or hapten of interest can be exposed to varying concentrations of the putative ionic surface charge modifier in the presence of one or more conditions suitable for denaturing protein such as, for example, heat.

A person of ordinary skill upon reading this disclosure would also realize that when heat is used to denature, the amount of heat can vary, and an exact temperature need not be determined. The goal is to expose the antigen preparation, in a denatured state, to an ionic surface charge modifier. It is known in the art, for example, that different proteins/peptides will denature at different temperatures. Accordingly, the person of ordinary skill would select a test temperature range suitable for denaturing, for example, a particular antigen. In some circumstances, such as when preparing calibrators that comprise peptides or short polypeptides, the temperature of exposure to the ionic surface charge modifier can be significantly lower than 90° C., such as, for example, 80° C. Under most circumstances, any of one or more temperatures between 90° C. and 100° C. will suffice as a practical matter.

With the present disclosure in hand, a person of ordinary skill in the art can obtain a suitable concentration of an ionic surface charge modifier for a given antigen using the following procedure: (1) select an antigen; (2) expose the antigen to a range of two to three or more concentrations of a putative ionic surface charge modifier over, for example, a ten-fold range of ionic surface charge modifier concentration; (3) heat the mixture of antigen and ionic surface charge modifier at any of one or more temperatures between 90° C. to 100° C. for about 5-15 minutes (a convenient workable temperature is 95° C.; a convenient amount of time is 5 minutes); (4) allow the mixture to come to room temperature; and (5) test the performance of the treated calibrator at the range of concentrations in an immunoassay after storage in the ionic surface charge modifier over time, where the stable calibrator preparation is maintained at 37° C. This approach is applicable to antigens in general (i.e., proteins, polypeptides, non-protein antigens or haptens).

Ionic surface charge modifiers that result in more stable performance in the immunoassay over time are desirable for preparing stable calibrator preparations. A person of ordinary skill would realize that relatively more ionic surface charge modifier should be used where antigen preparations have higher amounts of non-calibrator protein in them, such as in the case of complex mixtures, cell lysates, or human serum, for example. For complex mixtures such as human serum, it may be desirable to dilute the sample about 1:5 in a suitable buffer, and employ a concentration of an ionic surface charge modifier, such as, for example, SDS, of about 0.01 weight percent to about 0.1 weight percent.

In various embodiments where the ionic surface charge modifier is SDS, suitable concentrations of SDS in a liquid formulation comprising a protein antigen or polypeptide antigen for preparation of a calibrator include, for example, the following weight percentage ranges: 0.001 to 4, 0.01 to 2, 0.02 to 1, 0.03 to 0.75, and 0.04 to 0.5. A convenient weight percent range for SDS is 0.04 to 0.33. Stable calibrator preparations can be stored in the SDS at any of the indicated ranges. The recited ranges are also applicable to liquid formulations comprising a non-protein antigen or hapten of interest.

In various embodiments, the stable immunoassay calibrator preparation comprises a protein antigen, polypeptide antigen, non-protein antigen or hapten that has been heated in the presence of the ionic surface charge modifier. In various embodiments, the heating is carried out at one or more temperatures from about 60° C. to about 100° C. Preferred temperature ranges include from about 80° C. to about 100° C., preferably from about 90° C. to about 100° C., or from about 90° C. to about 95° C.

In various embodiments, heating can be carried out from about one minute to about 30 minutes or more. More preferably, heating is carried out from about one minute to about 15 minutes, preferably from about five minutes to about 15 minutes, or from about three minutes to about five minutes. In a specific embodiment, the protein antigen, polypeptide antigen, non-protein antigen or hapten, in a liquid preparation, is heated in the presence of 0.125 weight percent SDS to 1.33 weight percent SDS at any of one or more temperatures from 90° C. and 100° C. for three to five minutes. In another specific embodiment, the antigen in a liquid preparation is heated in the presence of about 0.125 weight percent SDS to 1.33 weight percent SDS for a period of five to 15 minutes at any of one or more temperatures from 80° C. and 100° C. In another specific embodiment, the liquid preparation is heated in about 0.125 weight percent SDS to 1.33 weight percent SDS for five to 15 minues at any of one or more temperatures from 90° C. to 100° C.

Preparations treated in accordance with the present invention, and the compositions and kits, can be stored under any suitable conditions. Suitable conditions include storage at one or more temperatures under freezing temperature, storage at one or more temperatures above freezing temperature but under 25° C., storage at one or more temperatures between about 4° C. and about 40° C., storage at one or more temperatures between about 10° C. and about 40° C., storage at one or more temperatures between about 15° C. and about 37° C., storage at one or more temperatures between about 20° C. and about 37° C., and storage between about 23° C. and about 37° C. One suitable storage temperature is ambient temperature in a laboratory, which is generally about 25° C.

Prior to dilution to working strength in an immunoassay, the calibrator in the preparation is preferably stable at one or more temperatures from 5° C. to 25° C. for at least 44 days. More preferably, the calibrator is stable at one or more temperatures from 5° C. to 25° C. for at least 100 days. More preferably, the calibrator is stable at one or more temperatures from 5° C. to 25° C. for at least 150 days. More preferably, the calibrator is stable at one or more temperatures from 5° C. to 25° C. for at least 409 days, more preferably, the calibrator is stable at one or more temperatures form 5° C. to 25° C. for more than 409 days. Exemplary but nonlimiting stability ranges are provided in the Examples herein.

Prior to dilution to working strength in an immunoassay, the calibrator in the preparation is more preferably stable at one or more temperatures from 25° C. to 37° C. for at least 44 days. More preferably, the calibrator is stable at one or more temperatures from 25° C. to 37° C. for at least 100 days. More preferably, the calibrator is stable at one or more temperatures from 25° C. to 37° C. for at least 150 days. More preferably, the calibrator is stable at one or more temperatures from 25° C. to 37° C. for at least 409 days, more preferably, the calibrator is stable at one or more temperatures from 25° C. to 37° C. for more than 409 days. Exemplary but nonlimiting stability ranges are provided in the Examples herein.

Following storage at any length of time in the mixture in which the calibrator was denatured and exposed to the ionic surface charge modifier, the calibrator is diluted to working strength, if necessary, for an immunoassay. Following dilution to working strength for an immunoassay (wherein the dilution buffer need not contain an ionic surface charge modifier), the calibrator preparation is preferably stable at one or more temperatures between about 4° C. and about 25° C. for at least one hour, more preferably, at least four hours, more preferably at least 12 hours, more preferably at least 24 hours, more preferably at least 10 days, at least 20 days, at least 30 days, at least 60 days, at least 90 days, at least 120 days, at least 240 days, at least 360 days, at least 409 days, and greater than 409 days. Exemplary but nonlimiting stability ranges are provided in the Examples herein.

Following dilution to working strength for an immunoassay (wherein the dilution buffer need not contain an ionic surface charge modifier), the calibrator preparation is preferably stable at one or more temperatures between about 25° C. and 37° C. for at least 1 hour, more preferably at least four hours, more preferably at least 12 hours, more preferably at least 24 hours, more preferably at least 10 days, at least 20 days, at least 30 days, at least 60 days, at least 90 days, at least 120 days, at least 240 days, at least 360 days, at least 409 days, and greater than 409 days. Exemplary but nonlimiting stability ranges are provided in the Examples herein. For example, a calibrator in accordance with the invention comprising recombinant human troponin single chain (from E. coli) can remain stable for at least 409 days.

In various embodiments, stability for the above mentioned time periods is measured by performance of the calibrator, having been stored at the indicated storage time(s) and temperature(s) in an immunoassay. Preferably, the calibrator preparation is stable if it retains at least about 85% of its activity on day N of storage as compared to its activity on Day 0 (for storage from Day 0 to Day N in the presence of the ionic surface charge modifier, where Day 0 is the day when the calibrator preparation is first prepared, i.e., the day of denaturation and exposure to the surface charge modifier), more preferably the calibrator preparation is stable if it retains at least about 90% of its activity on day N of storage as compared to Day 0, more preferably at least about 95% of its activity on Day N of storage as compared to Day 0, and most preferably at least about 100% of its activity on Day N of storage as compared to Day 0. For each phrase “at least about” in this paragraph, the upper limit is preferably about 100%, most preferably 100%. In certain circumstances, such as, for example, with native human troponin, instability can be reflected by activity well in excess of 100%.

Stability for the above mentioned time periods is measured (when maintained for the indicated time period under the indicated storage condition) by performance of the calibrator as a function of time after the calibrator has been diluted to immunoassay working strength. In these embodiments, a calibrator maintained at the indicated temperature range for the indicated period of time is diluted to working strength for an immunoassay in a suitable buffer. An aliquot of the calibrator is taken and its performance in an immunoassay is measured, for example, within an hour of its dilution to working strength, representing a first performance score in the immunoassay. In these embodiments, the calibrator is stable if the performance of the calibrator in the immunoassay, as measured by a second performance score in the immunoassay (wherein the second performance score is taken at least one hour after the first performance score) reflects at least 85% of the activity demonstrated by the first performance score, more preferably at least 90% of the activity demonstrated by the first performance score, more preferably at least 95%, and most preferably at least 100% of the activity demonstrated by the first performance score. In certain circumstances, such as, for example, with native human troponin, instability can be reflected by activity well in excess of 100%.

A third performance score can be determined (from an hour to 24 hours or 72 hours, for example, or one or more months) following the second performance score. In these embodiments, the calibrator preparation is stable if the first, the second, and the third performance scores preferably do not differ by more than 50%, more preferably do not differ by more than 40%, more preferably do not differ by more than 30%, more preferably do not differ by more than 20%, more preferably do not differ by more than 10%, and more preferably do not differ by more than 4%. Most preferably, the performance scores will differ by less than 4%. In practice, a coefficient of variance reflecting a difference of 4% or less is desirable. Thus, for a given calibrator preparation, the calibrator is preferably prepared and used at temperatures and storage conditions that promote a coefficient of variance reflecting a difference of 4% or less. The preferred ranges, performance scores, activities, and differences described in the foregoing paragraphs should be measured in light of instrument precision and accuracy, including variations due to instrument variability, buffer effects, etc.

In various embodiments, the calibrator preparation further comprises at least one stabilizer. Suitable stabilizers include common stabilizers such as, for example, glycerol; albumins such as bovine serum albumin and human albumin; amino acids such as arginine; commercially available stabilizers such as GUARD CHOICE, a proprietary formulation. The stabilizer can be added, if desired, after the polypeptide antigen, protein antigen, non-protein antigen or hapten has been exposed to the ionic surface charge modifier. In various embodiments where the antigen is heated in the presence of the ionic surface charge modifier, the stabilizer may be present while the antigen is exposed in a denatured state to the ionic surface charge modifier. In other embodiments, the stabilizer is added after the antigen has been exposed in a denatured state to the ionic surface charge modifier. In a specific embodiment, the stabilizer is glycerol preferably at 1% to 10%, and the antigen is exposed to the ionic surface charge modifier in the presence of the glycerol. In another specific embodiment, stabilizers can be bovine serum albumin and arginine, which are suitable stabilizers for, for example, troponin preparations.

Any suitable stabilizer known in the art can be used. The stabilizer can be separately treated in accordance with the invention. For example, a stock solution of bovine serum albumin can be treated in accordance with the invention and diluted, for example, in a stabilized matrix of the invention. The treated bovine serum albumin in the stabilized matrix can then be added to a calibrator preparation that has been treated in accordance with the invention. Alternatively, the stabilizer can be added to an antigen preparation, and the antigen preparation comprising the stabilizer can then be treated in accordance with the invention.

In another aspect, the invention provides a method for preparing a stable calibrator for an immunoassay, said method comprising the step of denaturing a polypeptide antigen or a protein antigen in the presence of an ionic surface charge modifier, wherein the polypeptide antigen or the protein antigen comprises an epitope that is specifically recognized by an antibody. The method can also be employed where the stable calibrator is to comprise a non-protein hapten.

In another aspect, the invention provides a method for preparing a stable calibrator for an immunoassay, said method comprising the step of exposing a non-protein antigen or hapten to conditions sufficient to denature protein, in the presence of an ionic surface charge modifier, wherein the non-protein antigen or hapten comprises an epitope that is specifically recognized by an antibody.

Calibrators made with the methods described herein can include all of the features described above in connection with the stable immunoassay calibrator preparations of the invention. For example, the stable calibrator can be prepared in a liquid medium and can be stored as a liquid or a solid. For example, the method can further comprise heating the antigen in the presence of the ionic surface charge modifier for at least about three minutes to about 15 minutes or more, at one or more temperatures from about 80° C. to about 100° C., the ionic surface charge modifier can be SDS (for example, in the concentrations described above), and any combination of the other features described above.

In another aspect, the invention provides kits for use with immunoassays, including calibrations kits. The calibration kits described below can include stable calibrator preparations described herein. The calibrator preparations can be made according to any suitable method described herein.

In various embodiments, the invention provides a calibration kit for an immunosassay. The kit may comprise a polypeptide antigen or protein antigen, wherein the polypeptide antigen or protein antigen has been denatured in the presence of an ionic surface charge modifier, and wherein the polypeptide antigen or protein antigen comprises an epitope that is recognized by an antibody. The kit can may comprise a non-protein antigen or hapten that has been exposed to conditions sufficient to denature protein, in the presence of an ionic surface charge modifier, wherein the non-protein antigen or hapten comprises an epitope that is specifically recognized by an antibody.

A preferred kit comprises a liquid calibrator preparation comprising a calibrator prepared using SDS as the ionic surface charge modifier, wherein the calibrator has been heated in the presence of SDS at one or more temperatures between about 80° C. and about 100° C. for about one to about 15 minutes.

In various embodiments, the invention provides a calibrator kit for an immunoassay, comprising: (a) a calibrator preparation comprising a polypeptide antigen or protein antigen, wherein the polypeptide antigen or protein antigen comprises an epitope that is recognized by an antibody, wherein the polypeptide antigen or protein antigen has been heated in the presence of an ionic surface charge modifier at one or more temperatures from about 80° C. to about 100° C. for a period of time from about one minute to about 15 minutes; and (b) an antibody that recognizes the polypeptide antigen or protein antigen.

In various embodiments, the invention provides a calibrator kit for an immunoassay, comprising: (a) a calibrator preparation comprising a non-protein antigen or hapten, wherein the non-protein antigen or hapten comprises an epitope that is recognized by an antibody, wherein the non-protein antigen or hapten has been heated in the presence of an ionic surface charge modifier at one or more temperatures from about 80° C. to about 100° C. for a period of time from about one minute to about 15 minutes; and (b) an antibody that recognizes the non-protein antigen or hapten.

The kit can comprise calibrators in liquid preparations that are either concentrated or dilute. The kit can also comprise two or more containers, wherein the concentration of antigen in the containers varies. For example, the kit can comprise containers with the antigen at one or more concentrations from, for example, 1×10⁻⁶ gram/ml to 1×10⁻⁹ gram/ml, or 1×10⁻⁶ gram/ml to 1×10⁻¹² gram/ml. The kit can comprise two or more antigens in a single container, with each antigen independently at the same or different concentrations. The kit can comprise one or more antigens isolated (i.e., wherein the one or more antigens is present substantially free from protein contaminants) or one or more antigens in a complex mixture such as, for example, human serum.

The kit can further comprise instructions for its use in any suitable format. The instructions can comprise any of the teachings disclosed herein, as well as information known in the art for carrying out, for example, tests using the components of the kits described herein. The tests can include, for example, FIAs, ELISAs, RIAs, and EIAs. The instructions can be provided with the kit in the form of printed matter (i.e., on paper), a CD-ROM, a DVD, a video, an interactive or non-interactive software program on computer-readable medium, or any other suitable form.

In another aspect, the invention provides a stabilized matrix for a calibrator for an immunoassay. The matrix can be any matrix suitable for storing a protein, polypeptide, or non-protein or hapten calibrator. The stabilized matrix is prepared by exposing a matrix to an ionic surface charge modifier under conditions sufficient for denaturing proteins or polypeptides, in accordance with any of the embodiments of the invention. Any suitable matrix known in the art can be employed. Suitable matrices include matrices used by those of skill in the art for immunoassays of proteins, polypeptides, non-protein antigens or haptens.

In another aspect, the invention provides kits for immunoassays, wherein the kits comprise a stabilized matrix for an immunoassay calibrator, wherein the stabilized matrix is prepared according to any of the embodiments of the invention.

In various embodiments, the invention provides a kit for an immunoassay, comprising: (a) a calibrator preparation comprising an antigen, wherein the antigen comprises an epitope that is recognized by an antibody; (b) a stabilized matrix comprising an ionic surface charge modifier, wherein the stabilized matrix comprising the ionic surface charge modifier has been heated at one or more temperatures from about 80° C. to 100° C. for a period of time from about one minute to about 30 minutes; and (c) an antibody that recognizes the antigen.

The kits can comprise any suitable components disclosed in connection with other embodiments. For example, the kits can comprise a non-protein antigen or hapten of interest. For example, the kit can further comprise a second antibody, the kit can comprise at least one antibody conjugated to an oligonucleotide, or an antibody of the kit can be biotinylated, etc.

The matrix of the kit can comprise any suitable stabilizers known in the art. Suitable stabilizers include, for example, human serum albumin, bovine serum albumin, and arginine.

The kit comprises a matrix that lacks high concentrations of one or more of urea, guanidinium hydrochloride, ethanol, dimethyl sulfoxide, mercaptoethanol and dithiothreitol. Preferably, the matrix does not contain an amount of chaotropic agent, such as, for example, urea or guanidinium hydrochloride, in an amount sufficient to denature a protein or polypeptide. More preferably, the matrix contains less than about 1 M chaotropic agent such as, for example, urea or guanadinium hydrochloride. More preferably, the matrix contains less than 1 mM urea or guanidinium hydrochloride. Most preferably, the matrix lacks urea and lacks guanidinium hydrochloride. Preferably, the ionic surface charge modifier of the matrix is SDS. The matrix can be conveniently treated as described in other embodiments, e.g., a convenient treatment is heating at one or more temperatures from about 90° C. to about 100° C. for about five to about 15 minutes in the presence of about 0.04 to about 0.33 weight percent SDS.

The methods and calibrators of the invention can be used in conjunction with any suitable immunosssay known in the art where a stable calibrator can be used, including, but not limited to, IFAs, ELISAs, RIAs, and EIAs. In various embodiments, the compositions, kits, and methods of the invention are used in liquid immunoassays such as IFAs, ELISAs, RIAs, and EIAs.

Suitable assays for use with the calibrators of the invention include sandwich and competitive immunoassays. The methods and calibrators of the invention can be used with any suitable sandwich and competitive immunoassay known in the art where a stable calibrator can be used. Examples of immunoassays provided below are meant to be illustrative, but not limiting.

One suitable sandwich immunoassay method is wherein a first antibody, such as, for example, a goat anti-mouse IgG, is conjugated to a paramagnetic particle. The first antibody goat anti-mouse IgG is complexed with a second antibody mouse anti-C (where C is a calibrator), and this complex is exposed to C (the calibrator). The complex is washed and then exposed to a goat anti-C that is conjugated to an enzyme, for example, alkaline phosphatase. A sandwich between the goat anti-mouse IgG/paramagnetic particle/mouse anti-C, C, and the alkaline phosphatase-conjugated goat anti-C is allowed to form, and the complex is washed. A suitable substrate for the alkaline phosphatase, for example, dioxetane-P is added, and the alkaline phosphate converts dioxetane-P to dioxetane, generating a detectable signal where antigen is present.

Another suitable sandwich immunoassay method is illustrated by the following assay for alpha-fetoprotein (AFP). In this sandwich assay, a paramagnetic particle coated with anti-AFP monoclonal antibody is exposed to an AFP calibrator in the presence of anti-AFP monoclonal antibody conjugated to alkaline phosphatase. A sandwich is allowed to form between the paramagnetic particle bearing the anti-AFP monoclonal antibody, the AFP calibrator, and the alkaline phosphatase-conjugated anti-AFP. The complex is washed, and then exposed to a suitable substrate for alkaline phosphatase, for example, dioxetane-P, as described above.

The methods, calibrators, and kits of the present invention can also be used in competitive assay formats. Competitive assay formats include, but are not limited to, progesterone assays, and the FT4 assay (hapten assay for thyroxine). The usefulness of preparing calibrators (for example, either substantially isolated calibrators or calibrators in complex mixtures) for hapten assays in accordance with the invention is related to increased stability of the hapten in an environment where elements of a mixture that can potentially destabilize a hapten in the mixture have been inactivated by denaturing in the presence of the ionic surface charge modifier. Accordingly, the calibrators of the invention can include non-protein or non-polypeptide haptens.

Suitable assay formats include, but are not limited to, assays and formats employed in the Examples herein. Such assays include those employing the Beckman Coulter A² MICROARRAY plate, wherein an antibody is coupled to a single stranded oligonucleotide.

The methods and calibrators of the present invention can also be used in high throughput or array screening. In one nonlimiting example, the calibrators can be used in an array of samples. For example, a first antibody capable of recognizing the calibrator (Ab₁-C) can be conjugated to an oligonucleotide. The oligonucleotide can be homologous to an oligonucleotide attached to a solid phase, such as an addressable array. In the addressable array, the identity of an oligonucleotide on the array is associated with a specific position on the array. In this way, when Ab₁-C binds to the array by virtue of its conjugated oligonucleotide, the position of the bound Ab₁-C on the array is known, since its position on the array is determined by the sequence of its oligonucleotide conjugate. In this assay, C is exposed to the array, Ab₁-C, and a second antibody. The second antibody is biotinylated Ab₂-C, capable of recognizing the calibrator. These assay components assemble to form a sandwich complex on the array: bound Ab₁-C/C/biotinylated Ab₂-C. The complex is washed and then exposed to a detectable streptavidin, for example, Streptavidin-SensiLight PBXK-1. Fluorescence of the detectable streptavidin molecule provides a method for detecting/quantitating the calibrator. Streptavidin-SensiLight PBXK-1 (Beckman Coulter, Inc., P/N A11880), is streptavidin labeled with PBXL-1, a microorganism-derived phycobiliprotein complex capable of providing a high fluorescence signal.

Accordingly, a kit of the present invention can comprise any calibrator in accordance with the present invention with at least one antibody capable of specifically recognizing the calibrator, wherein the at least one antibody is conjugated to an oligonucleotide. In a specific embodiment, the oligonucleotide is capable of hybridizing with an oligonucleotide printed on an addressable array of oligonucleotides. In various embodiments, the kit also comprises a second antibody capable of specifically recognizing the calibrator, wherein the second antibody comprises a detectable moiety, a moiety capable of binding a detectable moiety, or an enzyme capable of converting a substrate into a detectable moiety.

A kit of the present invention can comprise any calibrator in accordance with the present invention with at least one antibody capable of specifically recognizing the calibrator, wherein the at least one antibody is capable of binding to a solid phase. In a specific embodiment, the solid phase comprises a paramagnetic particle. The kit may also comprise a second antibody capable of specifically recognizing the calibrator, wherein the second antibody comprises a detectable moiety, a moiety capable of binding a detectable moiety, or an enzyme capable of converting a substrate into a detectable moiety.

The methods, compositions, and kits of the invention can be used with any suitable immunoassay system. Examples of suitable immunoassay systems include, but are not limited to, the ACCESS Immunoassay System and ACCESS² Mulitplex Immunoassay System, the SYCHRON LXi system, the TRIAGE system, the UniCel Dxl 800 ACCESS system, and the IMMAGE Immunochemistry System (all Beckman Coulter, Inc.). One suitable immunoassay array system is the A² MICROARRAY system (Beckman Coulter, Inc.).

In addition to the components disclosed herein for calibrator kits in general, calibrator kits specifically designed for use with the A² MICROARRAY system, or a similar system, preferably comprise a conjugation kit for conjugating oligonucleotides to an antibody that is capable of recognizing the calibrator, a plate comprising a surface having oligonucleotides printed thereon at known positions, at least one biotinylated antibody capable of recognizing the calibrator or an antibody biotinylation reagent, and a fluorophore conjugated to streptavidin. Any antigen described herein or known in the art can be prepared in accordance with the present invention and included in a kit for use with a microarray system.

A nonlimiting list of antigens for preparing calibrators includes inducible nitric oxide synthase (iNOS), CA19-9, IL-1α, IL-1 β, IL-2, IL-3, IL-4, IL-t, IL-5, IL-7, IL-10, IL-12, IL-13, sIL-2R, sIL-4R, sIL-6R, SIV core antigen, IL-1RA, TNF-α, IFN-gamma, GM-CSF; isoforms of PSA (prostate-specific antigen) such as PSA, pPSA, BPSA, inPSA, non-α₁-antichymotrypsin-complexed PSA, α₁-antichymotrypsin-complexed PSA, prostate kallikreins such as hK2, hK4, and hK15, ek-rhK2, Ala-rhK2, TWT-rhK2, Xa-rhK2, HWT-rhK2, and other kallikreins; HIV-1 p24; ferritin, L ferritin, troponin I, BNP, leptin, digoxin, myoglobin, B-type natriuretic peptide or brain natriuretic peptide (BNP), atrial natriuretic peptide (ANP); human growth hormone, bone alkaline phosphatase, human follicle stimulating hormone, human leutinizing hormone, prolactin; human chorionic gonadotrophin (e.g., CGα, CGβ); thyroglobulin; anti-thyroglobulin; IgE, IgG, IgG1, IgG2, IgG3, IgG4, B. anthracis protective antigen, B. anthracis lethal factor, B. anthracis spore antigen, F. tularensis LPS, S. aureas enterotoxin B, Y. pestis capsular F1 antigen, insulin, alpha fetoprotein (e.g., AFP 300), carcino embryonic antigen (CEA), CA 15.3 antigen, CA 19.9 antigen, CA 125 antigen, HAV Ab, HAV Igm, HBc Ab, HBc Igm, HIV½, HBsAg, HBsAg, HBsAb, HCV Ab, anti-p53, histamine; neopterin; s-VCAM-1, serotonin, sFas, sFas ligan, sGM-CSFR, s1CAM-1, sIL-2R, sIL4R, sIL6R, SIV core antigen, thymidine kinase, IgE, EPO, instrinsic factor Ab, haptoglobulin, anti-cardiolipin, anti-dsDNA, anti-Ro, Ro, anti-La, anti-SM, SM, anti-nRNP, antihistone, anti-ScI-70, ScI-70, anti-nuclear antibodies, anti-centromere antibodies, SS-A, SS-B, Sm, U1-RNP, Jo-1, CK, CK-MB, CRP, ischemia modified albumin, HDL, LDL, oxLDL, VLDL, troponin T, troponin I, microalbumin, amylase, ALP, ALT, AST, GGT, IgA, IgG, prealbumin, anti-streptolysin, chlamydia, CMV IgG, toxi IgG, toxo IgM, apolipoprotein A, apolipoprotein B, C3, C4, properdin factor B, albumin, α₁-acid glycoprotein, α₁-antitrypsin, α₁-microglobulin, α₂-macroglobulin, anti-streptolysin O, antithrombin-III, apolipoprotein A1, apolipoprotein B, β₂-microglobulin, ceruloplasmin, complement C3, complement C4, C-reactive protein, DNase B, ferritin, free kappa light chain, free lambda light chain, haptoglobin, immunoglobulin A, immunoglobulin A (CSF), immunoglobulin E, immunoglobulin G, immunoglobulin G (CSF), immunoglobulin G (urine), immunoglobulin G subclasses, immunoglobulin M, immunoglobulin M (CSF), kappa light chain, lambda light chain, lipoprotein (a), microalbumin, prealbumin, properdin factor B, rheumatoid factor, ferritin, transferrin, transferrin (urine), rubella IgG, thyroglobulin antibody, toxoplasma IgMKK, toxoplasma IgG, IGF-I, IGF-binding protein (IGFBP)-3, hepsin, pim-1 kinase, E-cadherein, EZH2, and a-methylacyl-CoA racemase, TGF-beta, IL6SR, GAD, IA-2, CD-64, neutrophils CD-64, CD-20, CD-33, CD-52, isoforms of cytochrome P450, s-VCAM-1, sFas, sICAM, hepatitis B surface antigen, thromboplastin, HIV p24, HIV gp41/120, HCV C22, HCV C33, hemoglobin A1c, and GAD65, IA₂.

Suitable antigens for use with the present invention include any of the WHO International Biological Reference Preparations held and, characterized, and/or distributed by the WHO International Laboratories for Biological Standards (available at http:/www.who.int/bloodproducts/re_materials, updated as of Jun. 30, 2005, which lists substances that are well known in the art; the list is herein incorporated by reference). A partial list of such suitable international reference standards, identified by WHO code in parentheses following the substance, includes: human recombinant thromboplastin (rTF/95), rabbit thromboplastin (RBT/90), thyroid-stimulating antibody (90/672), recombinant human tissue plasminogen activator (98/714), high molecular weight urokinase (87/594), prostate specific antigen (96/668), prostate specific antigen 90:10 (96/700); human plasma protein C (86/622), human plasma protein S (93/590), rheumatoid arthritis serum (W1066), serum amyloid A protein (92/680), streptokinase (00/464), human thrombin (01/580), bovine combined thromboplastin (OBT/79), anti-D positive control intravenous immunoglobulin (02/228), islet cell antibodies (97/550), lipoprotein a (IFCC SRM 2B), human parvovirus B19 DNA (99/800), human plasmin (97/536), human plasminogen-activator inhibitor 1 (92/654), platelet factor 4 (83/505), prekallikrein activator (82/530), human brain CJD control and human brain sporadic CJD preparation 1 and human brain sporadic CJD preparation 2 and human brain variant CJD (none; each cited in WHO TRS ECBS Report No. 926, 53^{rd} Report, brain homogenate), human serum complement components C1q, C4, C5, factor B, and whole functional complement CH50 (W1032), human serum immunoglobulin E (75/502), human serum immunoglobulins G, A, and M (67/86), human serum proteins albumin, alpha-1-antitrypsin, alpha-2-macroglobulin, ceruloplasmin, complement C3, transferring (W1031), anti-D negative control intravenous immunoglobulin (02/226), hepatitis A RNA (00/560), hepatitis B surface antigen subtype adw2 genotype A (03/262 and 00/588), hepatitis B viral DNA (97/746), hepatitis C viral RNA (96/798), HIV-1 p24 antigen (90/636), HIV-1 RNA (97/656), HIV-1 RNA genotypes (set of 10 I01/466), human fibrinogen concentrate (98/614), human plasma fibrinogen (98/612), raised A2 hemoglobin (89/666), raised F hemoglobin (85/616), hemoglobincyanide (98/708), low molecular weight heparin (85/600 and 90/686), unfractionated heparin (97/578), blood coagulation factor VIII and von Willebrand factor (02/150), human blood coagulation factor VIII concentrate (99/678), human blood coagulation factor XII plasma (02/206), human blood coagulation factors II, VII, IX, X (99/826), human blood coagulation factors II and X concentrate (98/590), human carcinoembryonic antigen (73/601), human C-reactive protein (85/506), recombinant human ferritin (94/572), apolipoprotein B (SP3-07), beta-2-microglobulin (B2M), human beta-thromboglobulin (83/501), human blood coagulation factor IX concentrate (96/854), human blood coagulation factor IXa concentrate (97/562), human blood coagulation factor V Leiden, human gDNA samples FV wild type, FVL homozygote, FVL heterozygote (03/254, 03/260, 03/248), human blood coagulation factor VII concentrate (97/592), human blood coagulation factor VIIa concentrate (89/688), human anti-syphilitic serum (HS), human anti-tetanus immunoglobulin (TE-3), human antithrombin concentrate (96/520), human plasma antithrombin (93/768), human anti-thyroglubulin serum (65/93), anti-toxoplasma serum (TOXM), human anti-toxoplasma serum (IgG) (01/600), human anti-varicella zoster immunoglobulin (W1044), apolipoprotein A-1 (SP1-01), human anti-interferon beta serum (G038-501-572), human anti-measles serum (66/202), anti-nuclear ribonucleoprotein serum (W1063), anti-nuclear-factor (homogeneous) serum (66/233), anti-parvovirus B19 (IgG) serum (91/602), anti-poliovirus serum Types 1,2,3 (66/202), human anti-rabies immunoglobulin (RAI), human anti-rubella immunoglobulin (RUBI-1-94), anti-smooth muscle serum (W1062), human anti-double-stranded DNA serum (Wo/80), human anti-E complete blood-typing serum (W1005), human anti-echinococcus serum (ECHS), human anti-hepatitis A immunoglobulin (97/646), human anti-hepatitis B immunoglobulin (W1042), human anti-hepatitis E serum (95/584), anti-human platelet antigen-1a (93/710), anti-human platelet antigen-5b (99/666), human anti-interferon alpha serum (B037-501-572), human alphafetoprotein (AFP), ancrod (74/581), human anti-A blood typing serum (W1001), human anti-B blood typing serum (W1002), human anti-C complete blood typing serum (W1004), anti-D (anti-Rh0) complete blood-typing reagent (99/836), human anti-D (anti-Rh0) incomplete blood-typing serum (W1006), and human anti-D immunoglobulin (01/572).

Examples of non-protein antigens or haptens for use with the invention include compounds that can be used as haptens to generate antibodies capable of recognizing the non-protein/non-polypeptide antigen, and include but are not limited to, any salts, esters, or ethers, of the following: hormones, including but not limited to progesterone, estrogen, and testosterone, progestins, corticosteroids, and dehydroepiandrosterone, and any non-protein/non-polypeptide antigens that are listed as international reference standards by the WHO. A partial list of such suitable international reference standards, identified by WHO code in parentheses following the substance, includes vitamin B12 (WHO 81.563), folate (WHO 95/528), homocystein, transcobalamins, T4/T3, and other substances disclosed in the WHO catalog of International Biological Reference Preparations (available at the WHO website, for example at page http://www.who.int/bloodproducts/ref_materials/, updated Jun. 30, 2005), which is incorporated herein by reference. The compositions and kits of the present invention can comprise one or more of the aforementioned WHO reference standards or mixtures containing a reference standard.

Examples of non-protein antigens or haptens that can be employed in the calibrator preparations, matrices, methods, and kits of the invention include drugs of abuse, wherein the drugs of abuse can be used as haptens to generate antibodies capable of recognizing the drugs.

Drugs of abuse include, for example, the following list of drugs and their metabolites (e.g., metabolites present in blood, in urine, and other biological materials), as well any salts, esters, or ethers, thereof: heroin, morphine, hydromorphone, codeine, oxycodone, hydrocodone, fentanyl, demerol, methadone, darvon, stadol, talwin, paregoric, buprenex; stimulants such as, for example, amphetamines, methamphetamine; methylamphetamine, ethylamphetamine, methylphenidate, ephedrine, pseudoephedrine, ephedra, ma huang, methylenedioxyamphetamine (MDS), phentermine, phenylpropanolamine; amiphenazole, bemigride, benzphetamine, bromatan, chlorphentermine, cropropamide, crothetamide, diethylpropion, dimethylamphetamine, doxapram, ethamivan, fencamfamine, meclofenoxate, methylphenidate, nikethamide, pemoline, pentetrazol, phendimetrazine, phenmetrazine, phentermine, phenylpropanolamine, picrotoxine, pipradol, prolintane, strychnine, synephrine, phencyclidine and analogs such as angel dust, PCP, ketamine; depressants such as, for example, barbiturates, gluthethimide, methaqualone, and meprobamate, methohexital, thiamyl, thiopental, amobarbital, pentobarbital, secobarbital, butalbital, butabarbital, talbutal, and aprobarbital, phenobarbital, mephobarbital; benzodiazapenes such as, for example, estazolam, flurazepam, temazepam, triazolam, midazolam, alprazolam, chlordiazepoxide, clorazepate, diazepam, halazepam, lorzepam, oxazepam, prazepam, quazepam, clonazepam, flunitrazepam; GBH drugs such as gamma hydroxyl butyric acid and gamma butyrolactone; glutethimide, methaqualone, meprobamate, carisoprodol, zolpidem, zaleplon; cannabinoid drugs such as tetrahydracannabinol and analogs; cocaine, 3-4 methylenedioxymethamphetamine (MDMA); hallucinogens such as, for example, mescaline and LSD.

Examples of non-protein antigens or haptens that can be employed in the calibrator preparations, matrices, methods, and kits of the invention include steroids and other drugs associated with performance enhancement, including those commonly encountered in illicit markets, or employed as ergogenic aids, such as, for example, the following compounds and any salts, esters, or ethers thereof; testosterone (including its esters with moieties such as, for example, enanthate, cypionate, and propionate), dihydrotestosterone (DHT), tetrahydrogestrinone, nandrolone, nortestosterone, methenolone, stanozolol, methandrostenolone, methandienone, androstenedione (e.g., 5a-androstan-3,17-dione), androstenediol such as 1-androstenediol (3β,17β-dihydroxy-5α-androst-1-ene;), 4-androstenediol (3b,17b-dihydroxy-androst-4-ene), 5-androstenediol (3b,17b-dihydroxy-androst-5-ene), androstendiones, such as 1-androstenedione ([5a]-androst-1-en-3,17-dione), 4-androstenedione (androst-4-en-3,17-dione), 5-androstenedione (androst-5-en-3,17-dione), norandrostenedione, 19-norandrostenediol, 19-norandrostenedione, norandrostenediol, dehydroepiandrosterone (DHEA), boldenone, fluoxymesterone, methandriol, methyltestosterone, oxandrolone, oxymetholone, trenbolone, clostebol, dehydrochloromethyltestosterone, dromostanolone, epitrenbolone, gestrinone, mesterolone, methanedienone, methenolone, norethandrolone, oxandrolone, oxymetholone, tetrahydrogestrinone (THG), trenbolone, clenbutorol, and steroids included in the Anabolic Steroid Control Act of 2004 (incorporated herein by reference), including 3b,17b-dihydroxy-5a-androstane; 3a,17b-dihydroxy-5a-androstane; androstanedione, bolasterone (7a,17a-dimethyl-17b-hydroxyandrost-4-en-3-one), boldenone (17b-hydroxyandrost-1,4,-diene-3-one), calusterone (7b,17a-dimethyl-17b-hydroxyandrost-4-en-3-one), clostebol (4-chloro-17b-hydroxyandrost-4-en-3-one), dehydrochlormethyltestosterone (4-chloro-17b-hydroxy-17a-methyl-androst-1,4-dien-3-one), 4-dihydrotestosterone (17b-hydroxy-androstan-3-one), drostanolone (17b-hydroxy-2a-methyl-5a-androstan-3-one), ethylestrenol (17a-ethyl-17b-hydroxyestr-4-ene), fluoxymesterone (9-fluoro-17a-methyl-11b, 17b-dihydroxyandrost-4-en-3-one), formebolone (2-formyl-17a-methyl-11a,17b-dihydroxyandrost-1,4-dien-3-one), furazabol (17a-methyl-17b-hydroxyandrostano[2,3-c]-furazan), 18a-homo-17b-hydroxyestr-4-en-3-one (13b-ethyl-17b-hydroxygon-4-en-3-one), 4-hydroxytestosterone (4,17b-dihydroxy-androst-4-en-3-one), 4-hydroxy-19-nortestosterone (4,17b-dihydroxy-estr-4-en-3-one), estanolone (17a-methyl-17b-hydroxy-5a-androstan-3-one), mesterolone (1a-methyl-17b-hydroxy-[5a]-androstan-3-one), methandienone (17a-methyl-17b-hydroxyandrost-1,4-dien-3-one), methandriol (17a-methyl-3b,17b-dihydroxyandrost-5-ene), methenolone (1-methyl-17b-hydroxy-5a-androst-1-en-3-one), ethyltestosterone (17a-methyl-17b-hydroxyandrost-4-en-3-one), mibolerone (7a,17a-dimethyl-17b-hydroxyestr-4-en-3-one), nandrolone (17b-hydroxyestr-4-en-3-one), norandrostenediol, 19-nor-4-androstenediol (3b,17b-dihydroxyestr-4-ene), 19-nor-4-androstenediol (3a,17b-dihydroxyestr-4-ene), 19-nor-5-androstenediol (3b,17b-dihydroxyestr-5-ene), 19-nor-5-androstenediol (3a,17b-dihydroxyestr-5-ene), norandrostenedione, 19-nor-4-androstenedione (estr-4-en-3,17-dione), 19-nor-5-androstenedione (estr-5-en-3,17-dione), norbolethone (18a-homo-17b-hydroxypregna-4-en-3-one), norclostebol (4-chloro-17b-hydroxyestr-4-en-3-one), norethandrolone (17a-ethyl-17b-hydroxyestr-4-en-3-one), oxandrolone (17a-methyl-17b-hydroxy-2-oxa-[5a]-androstan-3-one), oxymesterone (17a-methyl-4,17b-dihydroxyandrost-4-en-3-one), oxymetholone (17a-methyl-2-hydroxymethylene-17b-hydroxy-[5a]-androstan-3-one), stanozolol (17a-methyl-17b-hydroxy-[5a]-androst-2-eno[3,2-c]-pyrazole), stenbolone (17b-hydroxy-2-methyl-[5a]-androst-1-en-3-one), testolactone (13-hydroxy-3-oxo-13,17-secoandrosta-1,4-dien-17-oic acid lactone), 1-testosterone (17b-hydroxy-5a-androst-1-en-3-one), testosterone (17b-hydroxyandrost-4-en-3-one), tetrahydrogestrinone (13b,17a-diethyl-17b-hydroxygon-4,9,11-trien-3-one), trenbolone (17b-hydroxyestr-4,9,11-trien-3-one).

Examples of non-protein antigens or haptens that can be employed in the calibrator preparations, matrices, methods, and kits of the invention include antibiotics and other drugs administered to animals (including human beings) and whose detection is useful in clinical practice, and whose detection in a biological preparation can be achieved using an immunoassay. Examples of such drugs include antibiotics such as those listed in the WHO International Biological Reference preparations (available at http://www.who.int/bloodproducts/ref_materials/Ant-Sept05.pdf, updated as of 21 Sep. 2005, incorporated herein by reference). Examples include gentamicin (92/670), streptomycin (76/539), tobramycin (82/510), and vancomycin (50/020).

Kits of the present invention that comprise an antibody can comprise one or more antibodies to any one or more of the antigens described above. The antibodies may be polyclonal, monoclonal, recombinant, and/or humanized antibodies.

Any of the antigens listed above can be used in the present invention in substantially isolated form or in a mixture or complex mixture such as, for example, a cell lysate or tissue homogenate, or human serum, hemolysed blood, CHO cell lysate, bacterial cell culture lysate, mammalian cell culture lysate, human plasma or serum, recalcified human plasma or serum, human brain homogenate, mammalian mucosal extract, or any other suitable mixture. In various embodiments, a suitable mixture includes serum or plasma spiked with a recombinant antigen or antigen fragment.

Where the “polypeptide antigen” or “protein antigen” comprises another moiety, such as, for example, in a fusion with another protein such as GST, the “polypeptide antigen” and “protein antigen” refers to that portion of the construct that is recognized by a desired antibody. In an illustrative but nonlimiting example, for a fusion protein comprising GST and a polypeptide (PT), abbreviated as GST-PT, the desired antibody would typically be an antibody that specifically recognizes an epitope of PT, but not GST in the absence of PT. Thus, an antibody preparation capable of recognizing an epitope of PT is desirable in this instance, whereas an antibody preparation that is capable of recognizing GST only is undesirable in this instance.

An antibody preparation useful for specifically recognizing PT in a GST-PT construct, however, need not be altogether free of antibodies that recognize GST. As is known in the art, one method for preparing an antibody preparation that specifically recognizes PT over GST is to “pre-clear” an antibody preparation that recognizes one or more epitopes of GST-PT against a preparation comprising GST but not PT (e.g., an isolated GST preparation). The “pre-cleared” antibody preparation is then suitable for selectively recognizing an epitope on PT in the presence of GST. As is known in the art, this procedure—and variations of it known in the art—an be used for any suitable fusion between a desired antigen and an undesired antigen in a single mixture, including but not limited to antigen preparations comprising fusion proteins.

Calibrator preparations can include two or more antigens wherein the two or more antigens are present in fixed or varying ratios. Inclusion of two or more antigens in the same calibrator preparation can help reduce interassay variability for immunoassays detecting the presence of two or more antigens in a sample, in particular for quantitative determination of two or more antigens in a sample. For example, calibrator preparations comprising PSA antigen with α₁,-microglobulin antigen and/or α₂-macroglobulin antigen can be prepared with various ratios of each antigen, reflecting ratios of these antigens in various states of health or disease. Accuracy is improved in such multi-antigen calibrator preparations at least in part because inter-assay variability is reduced. A kit according to the invention can comprise one, two, three, four, five, six, seven, or eight or more separate tubes, each tube comprising a different ratio of two or more antigens. The antigens can be present substantially free of non-antigen protein contaminants, or can be a mixture of mixtures, for example, mixtures of human serum from two or more sources, or cell lysates from two or more sources.

For an example of a kit in accordance with the invention that can have two or more antigens, a single stable calibrator preparation can comprise two or more forms of PSA, or one or more isoforms of PSA present in a known ratio with α₁,-antichymotrypsin or α₂-macroglobulin.

In general, calibrator kits can comprise two or more calibrator preparations, wherein each calibrator preparation comprises two antigens that are capable of being detected by two different antibodies, wherein the ratios of the two antigens with respect to one another varies in each preparation. The kit can comprise, two, three, four, five, six, seven, eight, nine, or ten or more separate preparations, each preparation comprising a known ratio of two or more antigens. In this way, a kit is provided that can be used to generate a standard curve for an immunoassay, wherein the standard curve is constructed using calibrator preparations that comprise known ratios of two or more antigens. The calibrator preparations of the kit are preparations in accordance with the invention, or are made in accordance with any of the methods disclosed herein, and can contain two or more of any suitable antigen listed herein or known in the art. Kits comprising one or more calibrator preparations, wherein the calibrator preparations comprise two or more antigens in a known ratio, preferably include two or more antibodies, wherein the two or more antibodies independently are capable of recognizing each of the two or more antigens.

Nonlimiting examples of stable calibrator preparations prepared in accordance with the invention are described in Example 1. Example 1 illustrates preparation of four stable calibrator preparations: cardiac troponin I (cTnI), inducible nitric oxide synthase (iNOS), CA 19-9 antigen (GI MONITOR), and B-type natriuretic peptide (BNP). The calibrator preparation containing CA 19-9 antigen was present as a cell lysate, not a preparation of an isolated antigen. In these examples, the antigen was exposed to Laemmli sample buffer (Laemmli, U.K. (1970) Cleavage of structural proteins during the assembly of the head of bacteriophages T4, Nature 227:680-685), which contains the ionic surface charge modifier SDS.

Stability of calibrators were tested under a variety of conditions for each of the four calibrators. Example 2 illustrates the results of a stability study for a troponin I calibrator prepared in accordance with the present invention. The results indicate that performance of the troponin I calibrator stored at 37° C. for at least 14 days is about 7.8% different when compared with performance on the day the stable preparation was made. Up to 29 days, the maximal percent difference is about 15.1%. By day 44, the highest observed percent difference was 23.5. This study establishes that troponin I calibrators made in accordance with the present invention can be stored at temperatures that are at least at or around 37° C.

Example II also illustrates that treatment of at least two commercially available troponin I calibrator preparations exhibit enhanced stability when treated in accordance with the current invention. SCIPAC and HYTEST troponin I calibrator preparations were treated as described, and the stable preparations were diluted to working strength for an immunoassay and maintained at that dilution for a period of 24 hours at 37° C. The SCIPAC and HYTEST calibrators treated in accordance with the present invention displayed improved stability when stored dilute at 37° C. for 24 hours. In the case of the HYTEST calibrator, treatment resulted in about one-third of the percent difference displayed by the untreated HYTEST calibrator. This is particularly significant because the HYTEST calibrator for troponin I used here represents the WHO-recommended international standard biological reference material for cardiac troponin I. Accordingly, the present invention can improve the stability of internationally accepted reference standards known in the art.

Example 3 illustrates the stability of an iNOS calibrator prepared in accordance with the present invention. This study illustrates that for this stable iNOS calibrator preparation made from commercially available iNOS antigen and treated in accordance with the present invention, storage at a temperature as high as 37° C. for at least 72 days results in a percent difference of about a maximum −10.7%, and as low as about −3.8%.

Example 4 illustrates a stability study of CA 19-9 antigen calibrator preparations (CA 19-9 is used in the art in pancreatic cancer monitoring) carried out over a period of 100 days. Table VI shows results for one lot of the same CA 19-9 calibrator, and Table VII shows results for a second lot of the same CA 19-9 calibrator. In the first lot (Lot A), the highest percent difference in assay performance as measured by relative light units is about 3.0% for the calibrator treated in accordance with the present invention, whereas untreated calibrator exhibits a percent difference as high as −19.3%. For the second lot (Lot B), the calibrator preparation treated in accordance with the present invention displays a percent difference of at most about −5.5 during the 100 day testing period, whereas the untreated calibrator preparation displays a percent difference that is much higher, as high as −96.5 percent. Accordingly, the present invention provides enhanced stability over extended periods of time, up to 100 days or more, when calibrators are stored at temperatures as high as at least about 37° C.

Similarly, Example 5 illustrates the difference between stability of a commercially available B-type natriuretic peptide calibrator and the same calibrator after treatment according to the present invention. The untreated calibrator shows a percent difference in immunoassay performance of at least about −58.2 during a 44 day storage period at about 37° C., whereas the same calibrator treated according to the present invention exhibited at most a percent difference of about 5.0% over the same 44 day period.

Any of the features of the various embodiments described herein can be used in conjunction with features described in connection with any embodiments disclosed. For example, features disclosed in connection with the compositions of the invention can be employed in any kits according to the invention, methods described herein can be used in connection with making any of the compositions or kits described herein, etc. Features described in connection with particular embodiments are not to be construed as not suitable in connection with other embodiments disclosed herein unless such exclusivity is explicitly stated or implicit from the context.

### EXAMPLES

### Example 1

### Making Stable Calibrator Preparations

Stable calibrator preparations comprising protein/peptide antigens cardiac troponin (cTnl), inducible nitric oxide synthase (iNOS), BNP, and CA 19-9 were prepared by heating the protein/peptide antigens in sample buffer (SB) for 5-15 minutes at 90° C. -97° C. Sample buffer (SB) included 62.5 mM TRIS-HCI (pH 6.8), 25% glycerol, and 2% SDS. Protein/peptide antigens obtained as stock solutions from the manufacturer were mixed with 450 microliters of PBS and vortexed. One milliliter of SB was added, and heating was carried out. The resulting stable calibrator preparations were stored at ambient temperature unless otherwise indicated. Similarly, unless otherwise indicated, the stable calibrator preparations were maintained in the buffer indicated above, and dilutions of the calibrator preparations were made on the day of immunoassay.

Stock solutions of protein/peptide antigens, as obtained from the manufacturer, were stored frozen to maintain stability. Freeze-thaw cycles were kept at a minimum. Prior to preparation of calibrators, the protein/peptide antigens were allowed to thaw at room temperature. Aliquots of indicated volumes of the commercial protein/peptide antigen stock solutions as packaged by the manufacturer were treated in accordance with the protocol in Table I.

Briefly, stock antigen aliquots were added to phosphate buffered saline (PBS) and sample buffer (SB) was added. The mixture was heated at 90° C. to 97° C. for 15 minutes and allowed to come to room temperature. Unless otherwise indicated, the stabilized, treated preparations were stored as liquids at room temperature until use. On the day of use, the indicated aliquot of the stabilized, treated preparation was diluted in the indicated amount of PBS prior to immunoassay. The extent of final dilution for each antigen was the result of titrations that provided signals (i.e., relative light units, or RLU) in an acceptable range using Beckman Coulter ACCESS®, SYNCHRON LXi® and DxI® Immunoassay Systems, using an ACCESS® analyzer. Here, the final dilution for troponin was 1920X; for iNOS and BNP, 450X; and for GI Monitor, 30X in Table I.

TABLE I
TREATMENT PROTOCOL FOR CALIBRATOR PREPARATIONS

| | STOCK | | | | CALIBRATOR | |
|---|---|---|---|---|---|---|
| | ANTIGEN | PBS | SB | HEAT STEP | PREPARATION | PBS |
| CALIBRATOR | (μl) | (μl) | (μl) | (97° C.) | (μl) | (μl) |
| troponin (cTnl) | 50 | 450 | 1,000 | 5 min. | 8 | 500 |
| iNOS | 100 | 900 | 2,000 | 5 min. | 33 | 467 |
| ¹GI Monitor | 400 | 600 | 2,000 | 5 min. | neat | — |
| (CA19-9) | | | | | | |
| BNP | 50 | 450 | 1,000 | 15 min. | 33 | 467 |

¹GI MONITOR (CA19-9) was present as a cell lysate, not an isolated antigen

Stability of the troponin preparation prepared as described in Table 1 was assessed, and the results are shown in Table II.

TABLE II
TROPONIN CALIBRATOR STOCK STABILITY ON STORAGE AT 37° C.

| | SYNTHETIC MATRIX | | TROPONIN STABLE CALIBRATOR | |
|---|---|---|---|---|
| | RLU | % Difference | RLU | % Difference |
| | (mean) | from Day 0 | (mean) | from Day 0 |
| Day 0 | 11,698 | — | 29,088,200 | — |
| Day 3 | 11,961 | 2.1 | 30,554,750 | 5.0 |
| Day 8 | 13,287 | 13.6 | 30,115,200 | 3.5 |
| Day 14 | 12,529 | 7.1 | 31,357,450 | 7.8 |
| Day 21 | 13,197 | 12.8 | 33,485,150 | 15.1 |
| Day 29 | 15,773 | 34.8 | 32,360,950 | 11.3 |
| Day 44 | 23,717 | 103 | 35,930,800 | 23.5 |

### Example 2

### Troponin Calibrator Stability

A diluted troponin calibrator preparation of Example 1, stored at 25° C., was assayed for its stability over a period of 409 days. The calibrator was diluted (calibrator preparation+PBS) to the indicated level on the day of immunoassay. Troponin calibrator preparation stability was measured with the Beckman Coulter ACCESS®, SYNCHRON LXi® and DxI® Immunoassay System, using an ACCUTnI kit and Calibrator (P/N 33345) with an ACCESS® analyzer. Output is expressed in mean relative light units (RLU). Day 0 is the day that the troponin stable calibrator was prepared according to Example 1, and diluted for assessment as in Example 1.

Recombinant (E. coli) single chain human troponin calibrator has been stabilized by treatment in accordance with the invention for a period of over 400 days. Recombinant human cardiac single chain troponin I-C complex (Spectral Diagnostics Product Code RP-3500) was treated in accordance with the invention and maintained at various concentrations over a period of 409 days, where stability was assessed on Day 0, Day 374, and Day 409. Data are shown in Table III.

TABLE III
STABILITY OF A HUMAN RECOMBINANT (E. COLI) TROPONIN CALIBRATOR
PREPARATION TREATED IN ACCORDANCE WITH THE INVENTION
AND STORED IN DILUTED FORM

| TROPONIN | | | | | |
|---|---|---|---|---|---|
| CONC. | DAY 0 | DAY 374 | PERCENT | | PERCENT |
| (NG/ML) | (RLU) | (RLU) | DIFFERENCE | DAY 409 | DIFFERENCE |
| none | 9,366 | 10,472 | 11.81 | 10,057 | 7.38 |
| 0.3 | 49,141 | 54,421 | 10.75 | 48,321 | −1.67 |
| 1.2 | 137,377 | 14,917 | 4.76 | 121,810 | −11.33 |
| 5 | 433,459 | 458,781 | 5.84 | 414,163 | −4.45 |
| 25 | 1,973,170 | 2,185,500 | 10.76 | 1,970,680 | −0.13 |
| 100 | 6,115,285 | 6,857,595 | 12.14 | 6,498,465 | 6.27 |

Calibrator stability was studied as a function of time where calibrators were diluted to working strength and maintained at 37° C. for 24 hours. Immunoassays were performed as described above. Three commercially available cardiac troponin I preparations were tested: recombinant single chain expressed in E. coli (Spectral Diagnostics, prod. # RP-3500 recombinant human single chain I-C complex product), SCIPAC LTD. (troponin complex), and HYTEST native Troponin complex (I-T-C). Each commercial preparation was treated in accordance with the invention (“Treated”) as described in Example I, and maintained in final working dilution for 24 hours at 37° C. prior to immunoassay. The Untreated group employed the commercially available troponin calibrators without treatment. In the Untreated group, calibrators were diluted to working strength and maintained for 24 hours at 37° C. prior to immunoassay. Data is expressed as percent difference in relative light units between samples taken immediately after dilution to working strength and samples maintained for 24 hours at 37° C.

TABLE IV
STABILITY OF COMMERCIAL TROPONIN PREPARATIONS AT
WORKING STRENGTH FOR 24 HOURS AT 37° C.

| | RECOMBINANT | SCIPAC | HYTEST |
|---|---|---|---|
| | (% | (% | (% |
| | DIFFERENCE) | DIFFERENCE) | DIFFERENCE) |
| UNTREATED | 83 | 127 | 272 |
| TREATED | 84 | 86 | 91 |

The results shown in Table IV indicate that each of the Untreated commercially available calibrators displayed variations in stability when stored at working strength for 24 hours. Both the SCIPAC and HYTEST calibrators displayed instability after dilution for 24 hours at 37° C. at working strength. In contrast, each of the commercially available calibrators, when treated in accordance with the methods of the present invention, displayed improved stability.

The most dramatic instability was observed with untreated HYTEST native troponin calibrator. This troponin preparation is the native protein extracted from human serum. Native troponin (as opposed to recombinant single strand troponin calibrators made in E. coli) is an unstable protein when maintained—untreated—at working strength dilution at 37° C. After 3 days of storage at 37° C. at working dilution, only 20% of the relative light units are observed as compared to assay immediately following dilution (data not shown). Instability of the native protein calibrator is a significant finding because native troponin is the recommended standard for an international reference calibrator by the World Health Organization (WHO). Treatment of the native troponin calibrator in accordance with the invention, however, dramatically reduces instability of the native protein diluted at working strength for 24 hours at 37° C.

### Example 3

### Inducible Nitric Oxide Synthase Calibrator Stability

A calibrator preparation of inducible nitric oxide synthase (iNOS) was prepared according to the protocol of Example 1, stored at 37° C., and periodically assayed for stability over 72 days. The calibrator was diluted (calibrator preparation+PBS) to the indicated level on the day of immunoassay. iNOS calibrator preparation stability was measured with the Beckman Coulter ACCESS®, SYNCHRON LXi® and DxI® Immunoassay Systems, using an ACCESS® analyzer. Output is expressed in mean relative light units (RLU). Day 0 is the day that the iNOS stable calibrator was prepared according to Example 1.

TABLE V
iNOS CALIBRATOR STABILITY ON STORAGE AT 37° C.

| | SYNTHETIC MATRIX | iNOS STABLE CALIBRATOR | |
|---|---|---|---|
| | RLU | RLU | % Difference |
| | (mean) | (mean) | from Day 0 |
| Day 0 | 24,578 | 243,162 | — |
| Day 51 | 20,343 | 233,864 | −3.8 |
| Day 52 | 14,272 | 232,645 | −4.3 |
| Day 68 | 13,755 | 217,154 | −10.7 |
| Day 72 | 15,951 | 232,336 | −4.5 |

Treatment of iNOS in accordance with the invention conveys significant stability on the iNOS calibrator. At 37° C., iNOS preparations treated in accordance with the invention are highly stable for at least 72 days without any significant trend toward instability.

### Example 4

### CA 19-9 Calibrator Stability

Stability of two lots (Lot A and Lot B) of the same calibrator, antigen CA 19-9, commercially available as ACCESS GI MONITOR from Beckman Coulter, Inc. (P/N 387688) was measured over 100 days with and without treatment in accordance with the present invention. Treated calibrator preparations (“Lot A Treated 37° C.” and “Lot B Treated 37° C.”) were prepared by mixing 400 microliters of commercial calibrator with 600 microliters of PBS and vortexing. Two milliliters of sample buffer containing the ionic surface charge modifier SDS (prepared as in Example 1), were added and the sample was heated for 5 minutes in a water bath at approximately 100 ° C. Following treatment, the sample was stored at 37° C. for the period of time indicated in Tables VI and VII (i.e., 0 to 100 days). On the indicated day, a 200 microliter aliquot of each sample was assayed using the Beckman Coulter ACCESS®, SYNCHRON LXi® and DxI® Immunoassay Systems and measurements were made on an ACCESS®, analyzer.

Controls (“Lot A Control 37° C.” and “Lot B Control 37° C.”) were prepared in the absence of an ionic surface charge modifier by mixing 400 microliters of the commercially available CA19-9 calibrator (GI MONITOR) with 600 microliters of PBS and vortexing. Two milliliters of Tris-HCI buffer were added, and the controls were stored at 37° C. for the period of time indicated in Tables VI and VII. On the indicated day, a 200 microliter aliquot was assayed using the same system as the treated samples.

“Tris” refers to a buffer blank measured to reflect background variability of the assay on the detection instrument employed.

“SS 4° C.” refers to untreated commercially available CA 19-9 calibrator preparation (GI MONITOR) stored at 4° C. for the indicated period of time, in the absence of denaturation and in the absence of treatment with an ionic surface charge modifier.

Output is expressed in mean relative light units (RLU). “% Diff. Day 0” reflects percent difference between mean RLU on Day 0 and mean RLU on the indicated day. “% Diff. Treated” reflects percent difference between Lot A calibrator that has been treated in accordance with the invention and Lot A calibrator that has not been treated in accordance with the invention.

Results for Lot A of the calibrator, presented with controls for comparison, are presented in Table VI.

TABLE VI
CA19-9 CALIBRATOR STABILITY - LOT A

| | TRIS | SS 4° C. | | LOT A TREATED 37° C. | | LOT A CONTROL 37° C. | |
|---|---|---|---|---|---|---|---|
| Day | RLU | RLU | % DIFF. | RLU | % DIFF. | RLU | % DIFF. |
| No. | (MEAN) | (MEAN) | DAY 0 | (MEAN) | DAY 0 | (MEAN) | TREATED |
| 0 | 18,507 | 5,094,235 | — | 5,272,900 | — | — | — |
| 7 | 10,864 | 5,105,145 | 0.2 | 5,351,090 | 1.5 | 4,811,005 | −10.1 |
| 11 | 11,202 | 4,964,610 | −2.5 | 5,282,185 | 0.2 | 4,582,180 | −13.3 |
| 15 | 11,688 | 5,112,390 | 0.4 | 5,364,455 | 1.7 | 4,731,470 | −11.8 |
| 21 | 11,106 | 5,018,025 | −1.5 | 5,234,570 | −0.7 | 4,581,045 | −12.5 |
| 28 | 11,283 | 5,016,895 | −1.5 | 5,339,775 | 1.3 | 4,734,400 | −11.3 |
| 35 | 11,247 | 4,995,190 | −1.9 | 5,246,570 | −0.5 | 4,407,435 | −16.0 |
| 42 | 11,247 | 4,953,035 | −2.8 | 5,378,390 | 2.0 | 4,347,790 | −19.2 |
| 49 | 10,999 | 5,137,455 | 0.8 | 5,428,690 | 3.0 | 4,378,640 | −19.3 |
| 100 | 14,259 | 4,376,290 | −14.1 | 5,155,320 | −2.2 | 3,949,375 | −23.4 |

Results for Lot B of the calibrator, presented with controls for comparison, are presented in Table VII.

TABLE VII
CA19-9 CALIBRATOR STABILITY - LOT B

| | TRIS | SS 4° C. | | LOT B TREATED 37° C. | | LOT B CONTROL 37° C. | |
|---|---|---|---|---|---|---|---|
| Day | RLU | RLU | % DIFF. | RLU | % DIFF. | RLU | % DIFF. |
| No. | (MEAN) | (MEAN) | DAY 0 | (MEAN) | DAY 0 | (MEAN) | TREATED |
| 0 | 18,507 | 5,094,235 | — | 5,771,845 | — | — | — |
| 7 | 10,864 | 5,105,145 | 0.2 | 5,802,630 | 0.5 | 4,909,110 | −15.4 |
| 11 | 11,202 | 4,964,610 | −2.5 | 5,659,595 | −1.9 | 4,352,930 | −23.1 |
| 15 | 11,688 | 5,112,390 | 0.4 | 5,820,350 | 0.8 | 4,107,105 | −29.4 |
| 21 | 11,106 | 5,018,025 | −1.5 | 5,814,505 | 0.7 | 3,639,260 | −37.4 |
| 28 | 11,283 | 5,016,895 | −1.5 | 5,823,385 | 0.9 | 3,237,960 | −44.4 |
| 35 | 11,247 | 4,995,190 | −1.9 | 5,628,940 | −2.5 | 2,515,390 | −55.3 |
| 42 | 11,247 | 4,953,035 | −2.8 | 5,795,580 | 0.4 | 2,183,850 | −62.3 |
| 49 | 10,999 | 5,137,455 | 0.8 | 5,812,805 | 0.7 | 1,732,000 | −70.2 |
| 100 | 14,259 | 4,376,290 | −14.1 | 5,453,190 | −5.5 | 191,825 | −96.5 |

### Example 5

### BNP Calibrator Stability

Stability of commercially available calibrator BNP (TRIAGE BNP TEST Kit from Beckman Coulter, Inc. (P/N 98202; a 30-amino acid polypeptide) was measured over 44 days with and without treatment in accordance with the present invention. Treated calibrator preparations (“BNP Treated”) were prepared by mixing 50 microliters of commercial calibrator with 450 microliters of PBS and vortexing. One milliliter of sample buffer containing the ionic surface charge modifier SDS (prepared as in Example 1), was added and the sample was heated for 5 minutes in a water bath at approximately 100 ° C. Following treatment, Day zero time points for with and without treatment at same signal levels were made then the samples were stored at 37° C. for the period of time indicated in Table VIII (i.e., 0 to 44 days) and were measured again at appropriate signal levels Control (“BNP Untreated”) was Standard calibrator S5 level (Beckman P/N 98202). On the indicated day, aliquots of stable calibrator (“BNP Treated”) were diluted 15-fold in PBS for the appropriate signal generating level assayed. On the indicated day, aliquots of control calibrator (“BNP Untreated”) were assayed undiluted. ACCESS®, SYNCHRON LXi® and DxI® Immunoassay Systems were employed and measurements were made on an ACCESS® analyzer.

Output is expressed in mean relative light units (RLU). “% Diff.” reflects percent difference between mean RLU on Day 0 and mean RLU on the indicated day. Results are provided in Table VIII.

TABLE VIII
BNP CALIBRATOR STABILITY AT 37° C.

| | | UNTREATED BNP | | TREATED BNP | |
|---|---|---|---|---|---|
| | PBS RLU | RLU | | RLU | |
| | (mean) | (mean) | % Diff. | (mean) | % Diff. |
| Day 0 | 27,413 | 15,074,100 | — | 16,211,250 | — |
| Day 4 | 25,573 | 13,685,350 | −9.2 | 16,009,400 | −1.2 |
| Day 8 | 25,685 | 13,053,300 | −13.4 | 16,679,150 | 2.9 |
| Day 14 | 22,473 | 12,536,450 | −16.8 | 16,837,300 | 3.9 |
| Day 21 | 23,237 | 11,443,500 | −24.1 | 16,833,200 | 3.8 |
| Day 29 | 23,660 | 9,884,910 | −34.4 | 17,022,050 | 5.0 |
| Day 44 | 19,667 | 6,299,780 | −58.2 | 15,623,700 | 3.6 |

1. A stable immunoassay calibrator preparation comprising:
(a) an antigen, wherein the antigen comprises an epitope that is recognized by an antibody; and
(b) an ionic surface charge modifier.

2. A stable immunoassay calibrator preparation according to claim 1, wherein the antigen comprises a protein or a polypeptide.

3. A stable immunoassay calibrator preparation according to claim 1, wherein the antigen comprises a non-protein antigen or hapten.

4. A stable immunoassay calibrator preparation according to claim 1, wherein the preparation comprises a liquid.

5. A stable immunoassay calibrator preparation according to claim 1, wherein the ionic surface charge modifier is sodium dodecyl sulfate.

6. A stable immunoassay calibrator preparation according to claim 1, wherein the preparation has been heated in the presence of the ionic surface charge modifier.

7. A stable immunoassay calibrator preparation according to claim 1, further comprising at least one of bovine serum albumin, glycerol, and arginine.

8. A stable immunoassay calibrator preparation according to claim 1, wherein the calibrator is stable when stored at one or more temperatures from 5° C. to 37° C. for at least 60 days.

9. A stable immunoassay calibrator according to claim 1, wherein the calibrator is stable when stored at one or more temperatures from 5° C. to 37° C. for at least 90 days.

10. A stable immunoassay calibrator according to claim 1, wherein the calibrator is stable when stored at one or more temperatures from 5° C. to 37° C. for at least 120 days.

11. A stable immunoassay calibrator according to claim 1, wherein the calibrator is stable when stored at one or more temperatures from 5° C. to 37° C. for at least 365 days.

12. A stable immunoassay calibrator preparation according to claim 6, wherein the preparation has been heated for one minute to 30 minutes at one or more temperatures from 80° C. to 100° C.

13.-39. (canceled)
